(19) United States
(12) Patent Application Publication
(10) Pub. No.: US 2026/0229194 A1
(43) Pub. Date: Aug. 6, 2026

(54) Method and Apparatus for Partial Refresh at Arbitrary Position on Electronic Shelf Label

(71) Applicant: Hanshow Technology Co., Ltd., Jiaxing, Zhejiang (CN)

(72) Inventor: Yanchen LI, Jiaxing, Zhejiang (CN)

(21) Appl. No.: 19/147,233

(22) PCT Filed: Jan. 11, 2024
(86) PCT No.: PCT/CN2024/071761

§ 371 Date: Jul. 10, 2025

(30) Foreign Application Priority Data
Jan. 12, 2023 (CN) 202310093181.6

(51) Int. Cl. G09G 3/34

(52) U.S. Cl. CPC G09G 3/344; G09G 2340/0435

(57) ABSTRACT

Disclosed in the present disclosure are a method and apparatus for partial refreshing at arbitrary position on an electronic shelf label. The method includes: dividing positional regions of pixels of a target image in an electronic shelf label, and non-refresh-required pixels are assigned to an identical positional region, and pixels which have identical pixel transition requirements are assigned to another identical positional region; determining a code of each positional region and a drive waveform corresponding to the code; and refreshing the pixels of the target image according to the drive waveform. The present disclosure can achieve partial refreshing at arbitrary position on the electronic shelf label.

### RELATED APPLICATION

The present disclosure claims priority to Chinese Patent Application NO. 202310093181.6 filed on Jan. 12, 2023, which is hereby incorporated by reference its entirety.

### TECHNICAL FIELD

The present disclosure relates to the technical field of electronic screens, and particularly to a method and apparatus for partial refreshing at arbitrary position on an electronic shelf label.

### BACKGROUND

This section is intended to provide background or context for embodiments of the present disclosure set forth in the claims. The description here is not admitted to be the prior art just because it is included in this section.

An electronic paper screen (E-paper) is a display screen manufactured using an electrophoretic display technology. Specifically, a drive voltage is applied to individual pixels through a control circuit on a Thin Film Transistor (TFT) substrate to achieve the effect of image displaying. As a reflective display screen, the electronic paper screen can maintain a current image for a long time without requiring continuous refreshing after image updating, resulting in exceptionally low power consumption. Because of various characteristics such as low power consumption, wide viewing angle, high contrast ratio, eye-friendly, etc., the electronic paper screen is increasingly widely used in many fields such as electronic shelf labels, electronic books, the digital signage, etc.

However, the existing electronic shelf label cannot achieve partial refreshing at arbitrary position on the display area. Therefore, at present, there is a lack of a technical solution to achieve partial refreshing of at arbitrary position on the electronic shelf label.

### SUMMARY

The embodiments of the present disclosure provide a method for partial refreshing at arbitrary position on an electronic shelf label, to achieve the partial refreshing at arbitrary position on the electronic shelf label, the method including:
dividing positional regions of pixels of a target image in an electronic shelf label, wherein non-refresh-required pixels are assigned to an identical positional region, and pixels which have identical pixel transition requirements are assigned to another identical positional region;
determining a code of each positional region and a drive waveform corresponding to the code; and
refreshing the pixels of the target image according to the drive waveform.

The embodiments of the present disclosure provide a device for partial refreshing at arbitrary position in an electronic shelf label, to achieve the partial refreshing at arbitrary position in the electronic shelf label, the device including:
a positional region division module configured to divide positional regions of pixels of a target image in an electronic shelf label, and non-refresh-required pixels are assigned to an identical positional region, and pixels which have identical pixel transition requirements are assigned to another identical positional region;
a code and drive waveform determination module configured to determine a code of each positional region and a drive waveform corresponding to the code; and a refreshing module configured to refresh the pixels of the target image according to the drive waveform.

The embodiments of the present disclosure further provide a computer device, including a memory, a processor and a computer program stored in the memory and executable on the processor, and when executing the computer program, the processor implements the afore-mentioned method for partial refreshing at arbitrary position on the electronic shelf label.

The embodiments of the present disclosure further provide a computer-readable storage medium, storing a computer program, when being executed by a processor, the computer program implements the afore-mentioned method for partial refreshing at arbitrary position in the electronic shelf label.

The embodiments of the present disclosure further provide a computer program product, including a computer program, when being executed by a processor, the computer program implements the afore-mentioned method for partial refreshing at arbitrary position on the electronic shelf label.

The embodiments of the present disclosure divide positional regions of pixels of a target image in an electronic shelf label, and non-refresh-required pixels are assigned to an identical positional region, and pixels which have identical pixel transition requirements are assigned to another identical positional region; determine a code of each positional region and a drive waveform corresponding to the code; and refresh the pixels of the target image according to the drive waveform. In the above refreshing process, full-screen refreshing and partial refreshing share a drive instruction, and it is unnecessary to separately set a drive instruction for the partial refreshing, so that the partial refreshing at arbitrary position can be achieved and be more flexible.

### BRIEF DESCRIPTION OF DRAWINGS

In order to more clearly explain the technical solutions in the embodiments of the present disclosure or in the prior art, the drawings to be used in the description of the embodiments or the prior art will be briefly introduced below. Obviously, the drawings involved in the following description only illustrate some embodiments of the present disclosure, and other drawings can be obtained by those of ordinary skill in the art according to these drawings without paying any inventive work. In the drawings:

FIG. 1 illustrates a schematic diagram of an electronic shelf label control system according to an embodiment of the present disclosure;

FIG. 2 illustrates a flowchart of a method for partial refreshing at arbitrary position on an electronic shelf label according to an embodiment of the present disclosure;

FIG. 3 illustrates images before and after refreshing of a three-color electronic shelf label according to an embodiment of the present disclosure;

FIG. 4 illustrates an encoding mapping scheme for color transition of an electronic shelf label according to an embodiment of the present disclosure;

FIG. 5 illustrates an encoding mapping scheme for color transition corresponding to pixels at three positions according to an embodiment of the present disclosure;

FIG. 6 illustrates a drive waveform of partial refreshing of an electronic shelf label according to an embodiment of the present disclosure;

FIG. 7 illustrates a flowchart of partial refreshing at arbitrary position according to an embodiment of the present disclosure; and

FIG. 8 illustrates a schematic diagram of an apparatus for partial refreshing at arbitrary position on an electronic shelf label according to an embodiment of the present disclosure.

### DESCRIPTION OF EMBODIMENTS

In order that the objectives, technical solutions and advantages of the embodiments of the present disclosure are clearer, the embodiments of the present disclosure will be further described in detail with reference to the drawings. Herein, the exemplary embodiments of present disclosure and the descriptions thereof are used to illustrate the present disclosure, but should not be used as limitations thereto.

First, the concepts involved in the present disclosure are explained.

Full-screen refreshing: all pixels on a screen are refreshed.

Partial refreshing: only some pixels on the screen are refreshed.

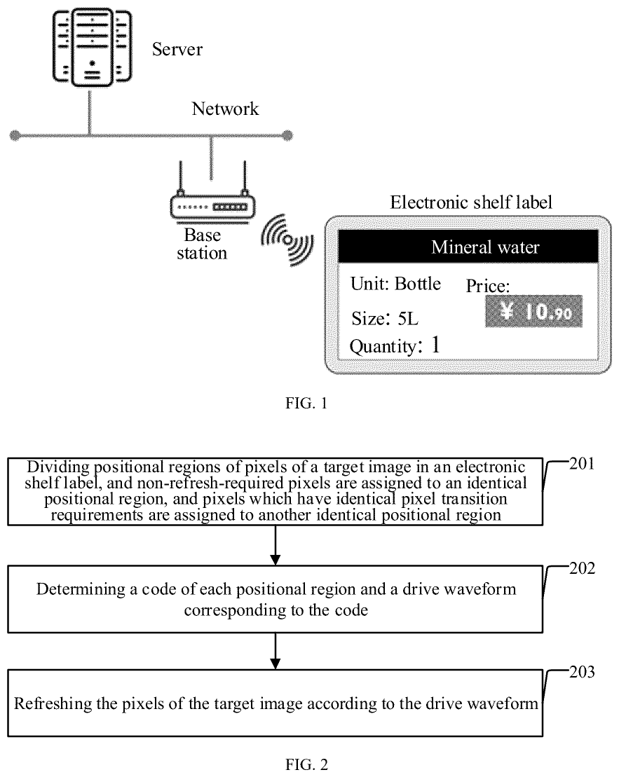

The electronic shelf label proposed by the embodiments of the present disclosure belongs to an electronic shelf label control system. FIG. 1 illustrates a schematic diagram of an electronic shelf label control system according to an embodiment of the present disclosure, including a server, a network, a base station and an electronic shelf label. The server is configured to store data, process data and control refreshing of an image (which may include pixels, for example) of the electronic shelf label; the network is configured to transmit data between the server and the base station; the base station is configured to transmit a control command and image data to the electronic shelf label; the electronic shelf label is configured to display image information (corresponding to the image data). After being processed by special software of the server, the image data is transmitted to the base station through the network, distributed to the designated electronic shelf label by the base station, and finally displayed on the electronic shelf label. Based on the system, a detailed solution of partial refreshing at arbitrary position on the electronic shelf label is given below. It should be noted that the text in the electronic shelf label in FIG. 1 is only for the understanding of the exemplary description, which is not limited in the specification.

FIG. 2 illustrates a flowchart of a method for partial refreshing at arbitrary position on an electronic shelf label according to an embodiment of the present disclosure, including:
step 201: dividing positional regions of pixels of a target image in an electronic shelf label, and non-refresh-required pixels are assigned to an identical positional region, and pixels which have identical pixel transition requirements are assigned to another identical positional region;
step 202: determining a code of each positional region and a drive waveform corresponding to the code; and
step 203: refreshing the pixels of the target image according to the drive waveform.

In an embodiment, the identical pixel transition requirement is a requirement for transitioning to identical color of the pixel. Of course, it should be noted that this solution may also be adopted when there are other pixel transition requirements.

In an embodiment, the dividing positional regions of pixels of a target image in an electronic shelf label may include, for example:
obtaining a current image and a target image of the electronic shelf label;
comparing data of identical positions in the current image and the target image one by one to determine the non-refresh-required pixels and the pixels which have identical pixel transition requirements;
dividing the non-refresh-required pixels into an identical positional region; and
dividing the pixels which have identical pixel transition requirements into another identical positional region.

Specifically, an electronic shelf label management system of a server respectively loads a current image and a target image of the electronic shelf label from a hard disk of the server, and compares data (including pixels, for example) of the identical positions in the current image and the target image one by one through a comparison program built in the electronic shelf label management system, so as to determine the non-refresh-required pixels and the pixels which have identical pixel transition requirements. For example, RGB color data of the pixels corresponding to the identical position is compared one by one to determine the non-refresh-required pixels and the pixels which have the identical pixel color transition requirement.

In an embodiment, the determining the code of each positional region and the drive waveform corresponding to the code may include, for example:
determining the code of each positional region according to the pixel transition requirement, and positional regions having identical post-transition pixel colors according to the pixel transition requirements are determined to have identical codes, and positional region where the non-refresh-required pixels are assigned is separately coded; and
determining a drive waveform corresponding to each code, and the drive waveform corresponding to the code of the positional region where the non-refresh-required pixels are assigned is consistent with a reference voltage waveform.

In an embodiment, the drive waveform includes a charge balancing phase, an activation phase and a color rendering phase.

A specific embodiment is given below to explain the specific application of the method given in the present disclosure.

The drive IC of the electronic shelf label supports 2-bits coding with four codes, i.e., 00, 01, 10 and 11. For the two-color and three-color electronic shelf labels, it is only necessary to use 00 and 01, and 00, 01 and 10 to complete coding. In this embodiment, the code 11 is used as a data protection code to separately code the non-refresh-required pixels in the image, and in conjunction with a specific drive waveform, it is possible to achieve the partial refreshing at arbitrary position in the electronic shelf label.

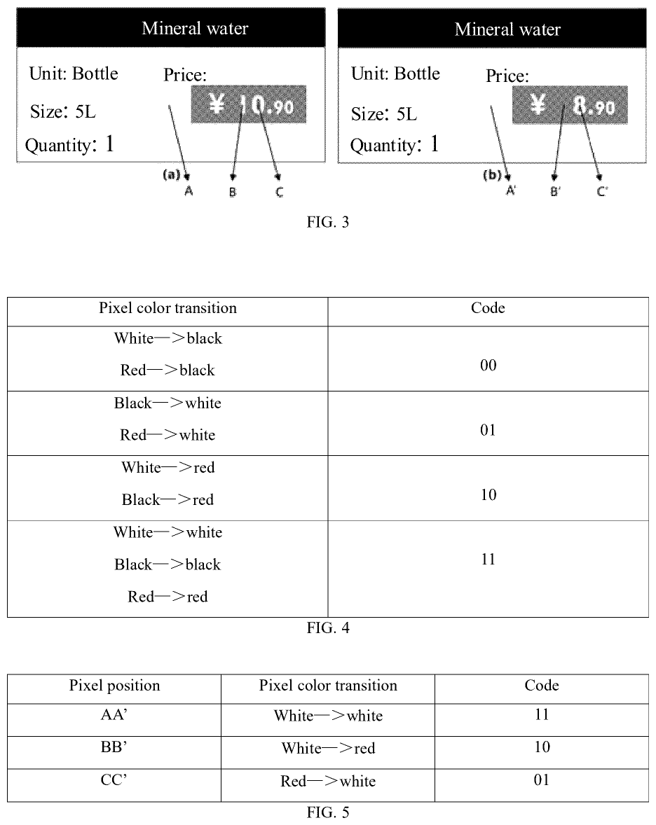

FIG. 3 illustrates images before and after refreshing of a three-color electronic shelf label according to an embodiment of the present disclosure. FIG. 3 (a) illustrates an image before refreshing of the electronic shelf label, i.e., the current image. FIG. 3 (b) illustrates an image after refreshing of the electronic shelf label, i.e., the target image. As can be seen from the comparison between FIG. 3 (a) and FIG. 3 (b), color information of only few pixels, rather than most pixels, in the images are transitioned before and after refreshing. For the convenience of explanation, three positional regions A, B and C in FIG. 3 (a) and three corresponding positional regions A′, B′ and C′ in FIG. 3 (b) are selected as examples, where AA′ represents the pixels having colors not transitioned before and after refreshing, i.e., the non-refresh-required pixels; and BB′ and CC′ represent the pixels having colors transitioned before and after refreshing, i.e., the pixels which have identical pixel transition requirement. In the embodiment of the specification, BB′ refers a transition from white to red (shown as gray in FIG. 3 (b)), and CC′ refers a transition from red (shown as gray in FIG. 3 (b)) to white. Through the above steps, the non-refresh-required pixels are assigned to an identical positional region, and the pixels which have requirements for transitioning to identical color of the pixel are assigned to another identical positional region, which reduces the workload of dividing the positional regions for a large number of non-refresh-required pixels, thereby improving the efficiency of partial refreshing at arbitrary position on the electronic shelf label. In addition, all pixels in the positional region where the non-refresh-required pixels are assigned do not require refreshing later, thereby saving the energy consumption. It should be noted that the text in the electronic shelf label in FIG. 3 is only for the understanding of the exemplary description, which is not limited in the specification.

FIG. 4 illustrates an encoding mapping scheme for color transition of an electronic shelf label according to an embodiment of the present disclosure. The corresponding codes are determined according to the color transitions of the pixels before and after refreshing. For example, the code is 00 in the cases of the color from white to black and the color from red to black; the code is 01 in the cases of the color from black to white and the color from red to white; the code is 10 in the cases of the color from black to red and the color from white to red; and the code is 11 in the cases of the color from black to black, the color from white to white and the color from red to red. In this way, the non-refresh-required pixels are coded separately. It should be noted that the pixel color transitions and the corresponding codes are only for the understanding of the exemplary description, which are not limited in the specification.

FIG. 5 illustrates an encoding mapping scheme corresponding to pixels having identical pixel transition requirements at three positions according to an embodiment of the present disclosure, in which AA′ represent the color from white to white, and the corresponding code is 11; BB′ represent the color from white to red, and the corresponding code is 10; and CC′ represent the color from red to white, and the corresponding code is 01.

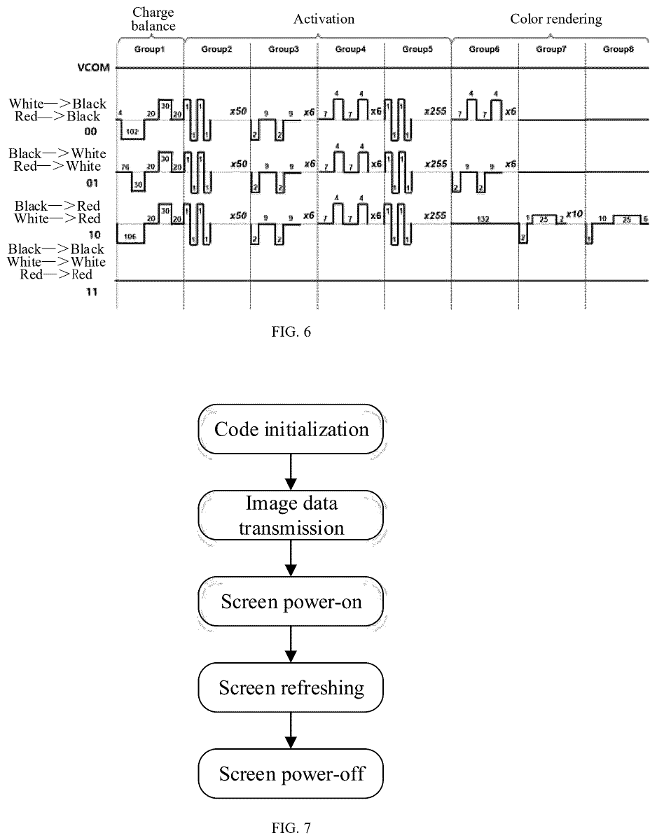

FIG. 6 illustrates a drive waveform of partial refreshing of an electronic shelf label according to an embodiment of the present disclosure. In an example, the drive waveform includes 8 groups, in which Group 1 is corresponding to a charge balancing phase, Groups 2 to 5 are corresponding to an activation phase, and Groups 6 to 8 are corresponding to a color rendering phase. The drive waveform supports the debugging of Common Electrode Voltage (VCOM), code 00, code 01, code 10 and code 11. In FIG. 6, a horizontal axis represents time, and each time unit (moment) is corresponding to one frame. In FIG. 6, a vertical axis represents voltages, which are respectively corresponding to four voltages: VSL-15V, VCOM OV, VSHR 5V and VSH 15V. In FIG. 6, the numbers represent the numbers of the frame for which a voltage is maintained, and x followed by a number (e.g., x50) represents the number of a waveform repetitions in a group. For example, by debugging the drive waveforms corresponding to three colors of black, white and red, the electronic shelf label can display the color information of the corresponding image at each pixel. The drive waveform of the code 11 is consistent with VCOM. In this way, for a pixel with a pixel transition requirement, corresponding color refreshing can be achieved through the drive waveform. For a pixel which does not need to be refreshed, because the drive waveform is consistent with VCOM, a drive voltage used to drive the movement of electronic ink in the pixel is always zero, and the pixel remains stationary (i.e., not refreshed) during the refreshing of the electronic shelf label. It should be noted that the pixel color transitions and the corresponding codes are only for the understanding of the exemplary description, which are not limited in the specification.

Through the above steps, the positional region where the non-refresh-required pixels are assigned is coded separately, in which the drive waveform corresponding to the code of the positional region where the non-refresh-required pixels are assigned is consistent with the reference voltage waveform. Therefore, when the electronic shelf label is to be refreshed, full-screen refreshing and partial refreshing share a drive instruction, and it is unnecessary to separately set a drive instruction for the partial refreshing, so that the partial refreshing can be achieved at arbitrary position and be more flexible.

FIG. 7 illustrates a flowchart of partial refreshing at arbitrary position according to an embodiment of the present disclosure, including the steps of code initialization, image data transmission, screen power-on, screen refreshing and screen power-off. The refresh sequence and refresh commands of the partial refreshing for example may be the identical as or similar to those of full-screen refresh. In a code initialization phase, it is necessary to read a drive waveform with a data protection code (e.g., a drive waveform exemplified in FIG. 6). In an image processing phase, it is necessary to transmit image data coded according to data protection rules (e.g., a code exemplified in FIG. 4).

Based on the above embodiments, the partial refreshing at arbitrary position on the electronic shelf label can be achieved by separately coding the data of the non-refresh-required pixels in the image, in conjunction with a specific drive waveform. In the embodiments, the electronic shelf label of three primary colors (black, white and red) is taken as an example, but in practical applications, the partial refreshing at arbitrary position on the electronic shelf label of two colors (black and white), three primary colors (black, white and red/black, white and yellow), four colors (black, white, red and yellow/blue, white, red and yellow) or more colors can also be achieved in this way, which is not specifically specified here. It should be noted that the two colors of black and white are only exemplary, and the electronic shelf label may be of any other two colors. Similarly, the three primary colors of black, white and red/black, white and yellow, and the four colors of black, white, red and yellow/blue, white, red and yellow are only exemplary, and the electronic shelf label may be of any other three or four colors. For the codes of the pixels which have identical pixel transition requirements, it is possible to adjust the pixel color transition requirement and the codes according to actual needs, which are not specifically specified here. There are many architectures for the drive waveform, which can all realize the color transition before and after the refreshing and are not specifically specified here.

The embodiments of the present disclosure further provide an apparatus for partial refreshing at arbitrary position on an electronic shelf label, with a principle similar to that of the method for partial refreshing at arbitrary position on the electronic shelf label, and the details are not repeated here.

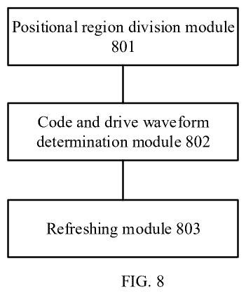

FIG. 8 illustrates a schematic diagram of an apparatus for partial refreshing at arbitrary position on an electronic shelf label according to an embodiment of the present disclosure, including:
a positional region division module 801 configured to divide positional regions of pixels of a target image in an electronic shelf label, and non-refresh-required pixels are assigned to an identical positional region, and pixels which have identical pixel transition requirements are assigned to another identical positional region;
a code and drive waveform determination module 802 configured to determine a code of each positional region and a drive waveform corresponding to the code; and a refreshing module 803 configured to refresh the pixels of the target image according to the drive waveform.

In an embodiment, the positional region division module is specifically configured to:
obtain a current image and a target image of the electronic shelf label;
compare data of identical positions in the current image and the target image one by one to determine the non-refresh-required pixels and the pixels which have identical pixel transition requirements;
divide the non-refresh-required pixels into an identical positional region; and divide the pixels which have identical pixel transition requirements into another identical positional region.

In an embodiment, the code and drive waveform determination module is specifically configured to:
determine the code of each positional region according to the pixel transition requirement, and positional regions having identical post-transition pixel colors according to the pixel transition requirements are determined to have identical codes, and positional region where the non-refresh-required pixels are assigned is separately coded; and
determine a drive waveform corresponding to each code, and the drive waveform corresponding to the code of the positional region where the non-refresh-required pixels are assigned is consistent with a reference voltage waveform.

In an embodiment, the drive waveform includes a charge balancing phase, an activation phase and a color rendering phase.

In an embodiment, the identical pixel transition requirement is an identical pixel color transition requirement.

The embodiments of the present disclosure further provide a computer device, including a memory, a processor and a computer program stored in the memory and executable on the processor, and when executing the computer program, the processor implements the method for partial refreshing at arbitrary position on the electronic shelf label.

The embodiments of the present disclosure further provide a computer-readable storage medium, storing a computer program, when being executed by a processor, the computer program implements the method for partial refreshing at arbitrary position on the electronic shelf label.

The embodiments of the present disclosure further provide a computer program product including a computer program, and when being executed by a processor, the computer program implements the method for partial refreshing at arbitrary position on the electronic shelf label.

Those skilled in the art should appreciate that any embodiment of the present disclosure can be provided as a method, a system or a computer program product. Therefore, the present disclosure can take the form of a full hardware embodiment, a full software embodiment, or an embodiment combining software and hardware. Moreover, the present disclosure can take the form of a computer program product implemented on one or more computer usable storage mediums (including, but not limited to, a magnetic disc memory, CD-ROM, optical storage, etc.) containing therein computer usable program codes.

The present disclosure is described with reference to a flowchart and/or a block diagram of the method, apparatus (system) and computer program product according to the embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory can produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable data processing devices to produce a processing realized by the computer, thus the instructions executed on the computer or other programmable devices provide step(s) for realizing function(s) specified in one or more flows in the flowchart and/or one or more blocks in the block diagram.

The specific embodiments further make detailed explanations to the objectives, technical solutions and advantageous effects of the present disclosure. It should be understood that those described above are only specific embodiments of the present disclosure and are not intended to limit the protection scope of the present disclosure. Any modification, equivalent substitution or improvement made within the spirit and principle of the present disclosure should fall within the protection scope of the present disclosure.

1. A method for partial refreshing at arbitrary position on an electronic shelf label, comprising:
dividing positional regions of pixels of a target image in an electronic shelf label, wherein non-refresh-required pixels are assigned to an identical positional region, and pixels which have identical pixel transition requirements are assigned to another identical positional region;
determining a code of each positional region and a drive waveform corresponding to the code; and
refreshing the pixels of the target image according to the drive waveform.

2. The method according to claim 1, wherein the dividing positional regions of pixels of a target image on an electronic shelf label comprises:
obtaining a current image and a target image of the electronic shelf label;
comparing data of identical positions in the current image and the target image one by one to determine the non-refresh-required pixels and the pixels which have the identical pixel transition requirements;
dividing the non-refresh-required pixels into an identical positional region; and
dividing the pixels which have identical pixel transition requirements into another identical positional region.

3. The method according to claim 1, wherein the determining the code of each positional region and the drive waveform corresponding to the code comprises:
determining the code of each positional region according to the pixel transition requirement, wherein positional regions having identical post-transition pixel colors according to the pixel transition requirements have identical codes, and positional region where the non-refresh-required pixels are assigned is separately coded; and
determining a drive waveform corresponding to each code, wherein the drive waveform corresponding to the code of the positional region where the non-refresh-required pixels are assigned is consistent with a reference voltage waveform.

4. The method according to claim 1, wherein the drive waveform comprises a charge balancing phase, an activation phase and a color rendering phase.

5. The method according to claim 1, wherein the identical pixel transition requirement is an identical pixel color transition requirement.

6. An apparatus for partial refreshing at arbitrary position on an electronic shelf label, comprising:
a positional region division module configured to divide positional regions of pixels of a target image in an electronic shelf label, wherein non-refresh-required pixels are assigned to an identical positional region, and pixels which have identical pixel transition requirements assigned to an identical positional region;
a code and drive waveform determination module configured to determine a code of each positional region and a drive waveform corresponding to the code; and
a refreshing module configured to refresh the pixels of the target image according to the drive waveform.

7. The device according to claim 6, wherein the positional region division module is specifically configured to:
obtain a current image and a target image of the electronic shelf label;
compare data of identical positions in the current image and the target image one by one to determine the non-refresh-required pixels and the pixels which have identical pixel transition requirements;
divide the non-refresh-required pixels into an identical positional region; and
divide the pixels which have identical pixel transition requirement into another identical positional region.

8. The device according to claim 6, wherein the code and drive waveform determination module is specifically configured to:
determine the code of each positional region according to the pixel transition requirement, wherein positional regions having identical post-transition pixel colors according to the pixel transition requirement have identical codes, and positional region where the non-refresh-required pixels are assigned is separately coded; and
determine a drive waveform corresponding to each code, wherein the drive waveform corresponding to the code of the positional region where the non-refresh-required pixels are assigned is consistent with a reference voltage waveform.

9. The device according to claim 6, wherein the drive waveform comprises a charge balancing phase, an activation phase and a color rendering phase.

10. The device according to claim 6, wherein the identical pixel transition requirement is an identical pixel color transition requirement.

11. A computer device, comprising a memory, a processor and a computer program stored in the memory and executable on the processor, wherein the processor to be programmed by the computer program to:
divide positional regions of pixels of a target image in an electronic shelf label, wherein non-refresh-required pixels are assigned to an identical positional region, and pixels which have identical pixel transition requirements are assigned to another identical positional region;
determine a code of each positional region and a drive waveform corresponding to the code; and
refresh the pixels of the target image according to the drive waveform.

12-13. (canceled)

14. The computer device according to claim 11, wherein the processor is to divide the positional regions of pixels of the target image on the electronic shelf label by:
obtaining a current image and a target image of the electronic shelf label;
comparing data of identical positions in the current image and the target image one by one to determine the non-refresh-required pixels and the pixels which have the identical pixel transition requirements;
dividing the non-refresh-required pixels into an identical positional region; and
dividing the pixels which have identical pixel transition requirements into another identical positional region.

15. The method according to claim 11, wherein the processor is to determine the code of each positional region and the drive waveform corresponding to the code by:
determining the code of each positional region according to the pixel transition requirement, wherein positional regions having identical post-transition pixel colors according to the pixel transition requirements have identical codes, and positional region where the non-refresh-required pixels are assigned is separately coded; and
determining a drive waveform corresponding to each code, wherein the drive waveform corresponding to the code of the positional region where the non-refresh-required pixels are assigned is consistent with a reference voltage waveform.

16. The method according to claim 11, wherein the drive waveform comprises a charge balancing phase, an activation phase and a color rendering phase.

17. The method according to claim 11, wherein the identical pixel transition requirement is identical pixel color transition requirement.
